(19) United States
(12) Patent Application Publication
(10) Pub. No.: US 2011/0262798 A1
(43) Pub. Date: Oct. 27, 2011

(54) ELECTROCHEMICAL STORAGE ELEMENT

(75) Inventors: Gerold Neumann, Halstenbek (DE); Peter Gulde, Itzehoe (DE); Andreas Wuersig, Itzehoe (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 13/003,133

(22) PCT Filed: Jul. 8, 2009
(86) PCT No.: PCT/EP09/58668

§ 371 Date: Jul. 15, 2011

(30) Foreign Application Priority Data
Jul. 8, 2008 (DE) 10 2008 032 068.4

(51) Int. Cl. H01M 6/46; H01M 10/04

(52) U.S. Cl. 429/149; 29/623.1

(57) ABSTRACT

The invention relates to an improved electrochemical construction or storage element for storing and discharging electric energy, characterized by a reduction or the prevention of a formation of magnetic stray fields. For this purpose the element has at least two electrochemical cells comprising the typical components. Said cells are disposed relative to each other such that a tag (12a) of a cell (20a), said tag being connected to the cathode accumulator, is positioned relative to a tag (12b) of an adjacent cell (20b) connected to the anode accumulator such that magnetic fields generated by moving electric charges in the tags (13a, 12b) overlap and substantially compensate each other.

The invention relates to an improved electrochemical device for storing and discharging electric energy. Such devices or storage elements are generally known in the form of batteries and accumulators in different sizes and configurations for various different applications. The present invention particularly relates to flat or thin batteries and accumulators consisting off foil-like layers, in particular lithium ion cells and lithium polymer cells. In both cases foils are used as a starting product for the electrodes and the separator that separates the electrodes from each other.

In lithium ion cells the foils are typically processed into a multilayer winding form and are pressed into a solid metal housing. Thereafter, a liquid electrolyte is then filled in and subsequently the battery housing is hermetically sealed.

Polymer cells are generally flat or thin cells that are also referred to as prismatic cells. In this case, the electrode foils are typically stacked and are firmly connected to each other by applying pressure and, if required, temperature or by gluing. The battery body is incorporated in a metallized plastic foil that also acts as housing or package, and the battery body is filled with electrolyte and is subsequently closed by sealing the housing foil perimeter. During the final closure a vacuum is established in the interior of the housing foil. In this cell type the electrolyte is incorporated into micro pores within the battery body, which are present in the electrode and separator structures, or the electrolyte is absorbed and made immobile in the layers by performing a gel-forming process for the polymer binder.

In both cell types the electrodes are connected to current discharging structures, ie. so-called current collectors or accumulators. Via these current collectors electrons are conducted from the electrodes to the contacts or from the contacts to the electrodes. The contacts connect the housing or package, by extending through its interior, with the environment and act as the electrical connections of the cells to the corresponding periphery. The contacts are also referred to as tags or package feed throughs or housing feed throughs. For contacting through the housing, for instance for each electrode a respective flat or thin metal band is used, which is welded into the sealed seam such that the package is hermetically closed.

The electrodes and, where necessary, the current collectors are laminar or two-dimensional structures in which a substantially bi-directional, and not a uni-directional, electron transport occurs. Contrary to this the housing feed throughs or tags are structures of substantially one-dimensional shape (for example in the form of thin contact tags or wires). They form an electric conductor in which a current flow occurs along a direction of an axis. In this case, magnetic fields are generated around the package feed throughs and tags during the charge and discharge events in a cell due to Maxwell's principle with respect to a current flow in a conductor.

The generation or presence of magnetic fields of varying or constant magnetic field strength is disadvantageous in certain applications, in particular during the discharge operation. As an example therefor, magnetic field measurement devices, in particular mobile grid-independent measurement devices for measuring disturbances of the terrestrial magnetic field are to be mentioned, as used for finding buried devices in archaeology. It is an established measurement procedure in archaeology to search for buried objects on the basis of minute disturbances of the terrestrial magnetic field. The requirements for any such measurement devices regarding the minimal operationally induced stray field are apparently extremely high, since disturbances down to one part in ten thousand of the terrestrial magnetic field are to be detected. For this reason, the requirement with respect to the stray field emanating from the measurement device itself under operation is in the same order of magnitude at most. Moreover, applications are contemplated in which the battery or accumulator itself shall not generate a magnetic field or shall generate a constant magnetic field independent from the current flow, for instance in medicine engineering or in military applications when sensors or positioning systems that are sensitive to the magnetic field are to be used.

Based on the above-described prior art it is an object of the invention to provide an electrochemical device for storing and discharging electric energy, which device is particularly appropriate for magnetic field sensitive applications and which generates a magnetic field as low as possible.

The object is solved by the present invention by means of an electrochemical device or storage element for storing and discharging electric energy, comprising at least two electrochemical cells, each of which having a laminar or two-dimensional cathode, a laminar or two-dimensional anode, a laminar separator, a cathode current collector connected to the cathode and an anode current collector connected to the anode, wherein the cathode and anode current collectors each are connected with a tag, and wherein the cells are positioned to each other such that a tag connected to the cathode current collector of one cell is positioned relative to a tag connected to the anode current collector of a neighbouring cell such that the magnetic fields generated by moving electric charges in the tags are superimposed and substantially cancel each other. It goes without saying that in one or more of these cells several anodes and cathodes, each pair separated by a separator, may rest on top of each other in a stack-like manner, as is known from the prior art. Already within the cells the current collectors are combined to a single cathode current collector and a single anode current collector, which are connected to respective tags.

An electrochemical device or storage element according to the present invention may be a battery or accumulator and is formed by using primary and secondary cells. The device is characterized by a substantially complete or at least a significant compensation of magnetic fields generated by a displacement of electric charges. Due to the extensive compensation of magnetic fields that are caused by moving charges the inventive device is always surrounded by a magnetic field that is already minimized in the close-up range (ie. approximately in a range of several centimetres). in applications in the context of magnetic field sensitive applications variations of the magnetic field caused by current flow are reduced or suppressed. The possibly remaining substantially constant magnetic field may advantageously be compensated in an efficient manner by measurement techniques.

The cells of the device or storage element are arranged preferable indirectly or directly adjacent to each other, in particular such that the respective tags of the cells having different polarity are indirectly or directly adjacent and/or are arranged closely to each other. Particularly advantageous are parallel arrangements, preferably stacked on top of each other, of the tags as well as an adjacent arrangement wherein the tags are electrically isolated from each other. The closer the tags are positioned to each other the more completely are compensated the magnetic field surrounding the tags. Consequently, it is very advantageous that the insulation is thin.

The arrangement of adjacent cells proposed by the present invention results in the avoidance of the generation of magnetic stray fields acting externally or results in the generation of such fields having a reduced effect, when a displacement of electric charges occurs during the charge and/or discharge operation. This is based on the fact that according to Maxwell's Law a displacement of charges through a conductor is always associated with the generation of a magnetic field surrounding the conductor and the cells are arranged to each other according to the present invention such that magnetic fields generated in this manner eliminate each other as efficiently as possible or are at least minimized. Components of the respective cells having opposite polarity, ie. inverse directions of charge carrier flow and thus opposite orientation of the magnetic field, are arranged according to the present invention to each other such that due to the opposite orientation of the magnetic field surrounding the components an extensive or complete mutual superimposition and elimination of these magnetic fields is effected.

Basically, each current conducting, ie. charge displacing, structure of the electrochemical device is affected by the generation of a magnetic stray field. Due to the operational behaviour, however, in the electrodes themselves opposite electron and ion currents occur, thereby resulting in a compensation of the magnetic fields. In the current collectors due to their construction there is a compensation of the magnetic fields generated due to the displacement of charges, since the current flow direction of the anode current collector with respect to that of the cathode current collector is opposite and the current collectors are typically very closely disposed to each other due to the laminar configuration of electrodes and separators, such that the magnetic fields substantially completely superimpose each other. Laminar or two-dimensional in this sense is to be understood as flat or thin, in particular plane or curved shapes and/or is to be understood as such elements having a reduced thickness compared to their length and width. Critically with respect to the generation of magnetic stray fields, however, remain in particular the electric feed throughs through the housing or package (tags) and the connection of the battery or the accumulator to the system environment. In particular these components form a conductor in the sense of Maxwell's Law having a structure that enables a substantially one-dimensional charge displacement oriented in one spatial direction.

The cells of the device or storage element are preferably lithium ion or lithium polymer cells. The number of cells of the inventive device is at least two. It is of particular advantage for the device to have an even number of cells, in particular more than two, since for an even number of cells—as implied by the above explanations—magnetic fields generated by charge displacement may be compensated for in a particularly efficient manner, wherein for each cell a further cell is provided that has a compensation with opposite magnetic field.

The cells are wound cells, as is usual in the lithium ion technology, wherein the foil-like devices of the cell are wound to a multilayer winding form and are pressed into a solid metal housing. This housing also includes the electrolyte that is present in liquid form, unless pure solid state ion conductivity is provided, and the housing is hermetically closed.

Alternatively, the cells may be layered or prismatic cells, as is general knowledge in the lithium polymer technology. These cells have the shape of flat cells and configure the device as a flat or thin storage element in that the cells are, for instance, arranged adjacent to each other in a plane manner. The electrodes of the cells are arranged in a stacked manner by using an intermediate layer of a separator and current collectors, for instance with the application of pressure and temperature, or the electrodes are joined to each other by gluing and are accommodated in a housing, for instance a metallized plastic foil. The housing is typically filled with an electrolyte and is hermetically sealed, for instance by sealing the foil perimeter of the housing. Upon finally closing the housing in its interior a vacuum is established. In this type of cell within the battery body the electrolyte is incorporated into a micro porous electrode and separator structure or is absorbed and made immobile in the layers by performing a gel-forming process of the polymer binder.

The individual components of the cell, for instance electrode, separator and current discharger, are formed in a flat manner (as a thin construction) or are formed from foils. The thickness of the electrodes is preferably in the range between 200 μm and 50 μm, without however being restricted to these layer thickness values. As is known to the skilled person, it is to be taken account of adjusted capacitance values of anodes and cathodes. The electrodes of the device according to the present invention are, in the case of lithium accumulators, materials at the anode side and the cathode side, which can accommodate or discharge lithium in a reversible manner without any significant structural changes of the host lattice. These materials may be, among others, lithium metal oxide compounds such as LiCoO₂, LiMn₂O₄, or other lithium compounds such as LiFePO₄, as is known to the skilled person. At the anode side preferably carbon is used in various modifications. A particularly safe and durable alternative to carbon is, for instance, Li₄Ti₅O₁₂. Instead of lithium technology also any other technology may be used for batteries or accumulators.

The thickness of a foil-like separator is preferably between 10 μm and 60 μm. The thickness of the current discharger is preferably in a range of 10 μm to 30 μm.

A thin battery element is obtained that consists of two current dischargers for anode and cathode, the anode and the cathode foils and the separator. Typically, the element is filled with an electrolyte liquid. The capacity may be increased by stacking and connecting in parallel a plurality of such elements within a battery housing. Various embodiments of any such elements, for instance for increasing the energy density, are well known to the skilled person.

By stacking and connecting in parallel the aforementioned components having the desired lateral dimensions, the desired target capacity may be adjusted from which a thickness of the cell is then obtained. The thickness is typically between 0.5 mm and 20 mm, without being restricted to these values. The inventive object is particularly advantageously solved with this construction technique, since it is possible to distribute any capacity requirement for the accumulator given by the intended usage to, for instance, two or a multiple thereof by dividing the number of battery elements in one housing into two cells or a multiple thereof, each having the adapted number of battery elements. These may then be assembled in the area of the feed throughs in a magnetic field compensating manner as described above.

The housing of lithium ion accumulators is a deep drawn metal cup that is typically made of aluminium. After inserting the battery body and after adding the electrolyte this cup is hermetically closed with a lid comprising the feed throughs by means of an appropriate joining process, such as laser welding. For polymer cells the packaging of the battery body is accomplished by means of an aluminium foil coated on both sides with plastic and which is sealed at the perimeter by a sealing step.

The magnetic field compensating assembly may particularly advantageously be accomplished by using a bifilar winding technique or by using a quadrupole arrangement. In the bifilar winding technique the conductors carrying the charge are assembled in the form of a braided pigtail. For non-flexible conductors, which do not allow any such braiding process, the quadrupole arrangement has been proven to be viable. Whether a bifilar winding technique or a quadrupole arrangement is used depends in the first place on the elasticity and the shape of the conductors or the tags. Since the current feed throughs or the contact tags of a lithium cell are typically provided in the form of metal bands that are not wound in a bifilar manner, in this case a quadrupole arrangement is particularly advantageous. The quadrupole arrangement is in particular effected in that the current storage element is not realized as a single cell but the capacity is divided into at least two cells that are connected as a magnetic field compensated unit.

Preferably, the cells have identical dimensions and a correspondingly reduced, preferably identical, capacity. Advantageously, they are arranged to each other such that the positive and negative current conductors are each exchanged in the sense of Maxwell. There is a particularly simple way to do this when the tags are symmetrically arranged with respect to a centre axis. Moreover, advantageously the positive tag may be arranged on one side of the centre axis and the negative tag may be arranged at the oppositely positioned side. In this case, the exchange of the polarities of the feed throughs or of the tags may advantageously be realized by using one cell type only by using an arrangement of the cells along the centre axis that is mutually rotated by 180°. If the feed throughs or tags are asymmetrically positioned with respect to the centre axis of the cell, then the desired arrangement of the compensation of the magnetic field may be achieved by two different embodiments that differ from each other by exchanging the polarities of the feed throughs or tags.

The further wiring of the inventive device following the tags or the feed throughs so as to connect, for instance, to a protective circuitry or to the periphery is preferably established with bifilar wound conductors. It is also possible that this further wiring is configured in the form of a quadrupole arrangement. The conductors of the further wiring may be welded or soldered to the tags.

According to a further embodiment of the invention the cells exclusively comprise non-permanent magnetic or substantially non-permanent magnetic materials. In combination with the previously described arrangements of the tags for compensating of magnetic fields that are caused by a charge displacement, electrochemical storage elements may thus be provided in this manner, which are substantially free of a magnetic field during the charging, discharging and also in the stand-by state. There is no requirement for compensation using control or regulation techniques with respect to constant or variable magnetic fields. In this sense, permanent magnetic or permanent-magnetisable materials are in particular ferro- or fern-magnetic substances, such as iron, nickel or cobalt, as well as other known materials. Otherwise it is necessary for usage of materials appropriate for the invention and which are para-magnetic or dia-magnetic that the susceptibility Xₘ of the material is significantly less than 1. This holds true, for instance, for the para-magnetic material aluminium, for which Xₘ=+20×10⁻⁶ and which is used as current discharger in lithium accumulators.

The known and presently used electrode materials in lithium batteries and accumulators are usually exclusively non-permanent-magnetisable or non-permanent magnetic materials, the same holds true for the electrolytes and binders used. The housing material is advantageously a two-sidedly plastic-coated aluminium that is also a non-permanent-magnetisable material. In particular, in the present context however, the selection of materials for the current collectors as well as for the tags or housing feed throughs is to be performed in any appropriate manner.

The selection of the materials of the current collectors depends on the electrode combination, since the stability of metals used therefor depends on the electrochemical potential conditions in the cell. In systems having graphite-based anodes and lithium metal oxide compounds it is advantageous to use copper on the anode and aluminium on the cathode. In commercial products, however, the housing feed through at the cathode side is typically configured as a nickel tag. This is disadvantageous since nickel is a ferro-magnetic material. According to a proposal of the invention, in this respect also the tags or feed throughs, in addition to the current collectors, are to be provided in the form of copper tags in order to obtain a non-magnetic configuration. One disadvantage of copper contacts as tags or feed throughs is, however, that these contacts are prone to oxidation when being in contact with the ambient atmosphere such that the attachment of conductors for connecting the device with the peripheral system is becoming increasingly difficult over time. This problem is solved according to a particularly advantageous embodiment of the invention by using a lithium titanium anode (Li₄Ti₅O₁₂) as an alternative to carbon-based anodes. In this configuration it is possible to use aluminium discharging elements on both electrode sides and also to provide tags or housing feed throughs in the form of aluminium tags.

In order to achieve increased clamp voltages according to the present invention advantageously two or more cells may be connected in series. A parallel connection is also contemplated herein. In both types of connections an optimum quadrupole arrangement may be obtained in the area of the current feed throughs in the context of the lithium polymer technology described herein, as long as an even number of cells is connected. The cells are stacked with alternating polarities of the current feed throughs so that respective positive and negative poles are positioned above each other. These are connected to each other by means of a series or parallel connection except for the outermost poles that are preferably connected to a load by means of a bifilarly wound conductor pair.

Furthermore, the invention relates to a method for fabricating an inventive electrochemical device, comprising the steps:
providing at least two primary or secondary cells preferably configured as flat or thin cells,
positioning the cells such that a tag of one cell connected to the cathode collector is positioned to a tag of a neighbouring cell connected to the anode current collector such that magnetic fields generated by moving electric charges in the tags superimpose and substantially compensate each other.

Further features and advantages of the invention result from the following illustrative description of particularly preferable embodiments when referring to the Figures.

In the Figures:

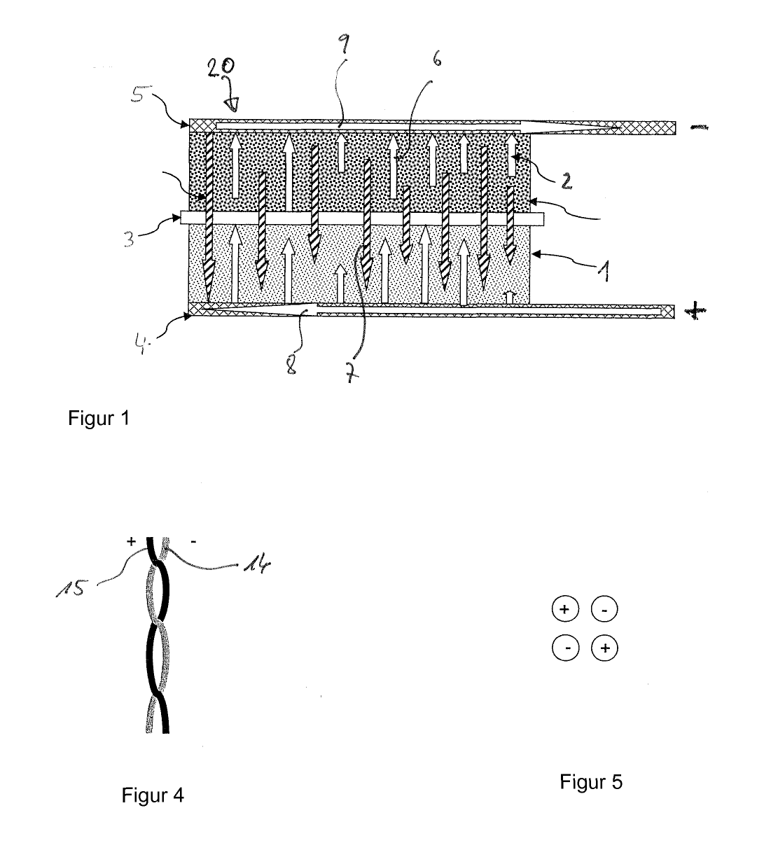

FIG. 1 illustrates the interior of an electrochemical cell as used in the invention in a schematic cross-sectional view,

FIG. 2 illustrates two cells in a schematic top view,

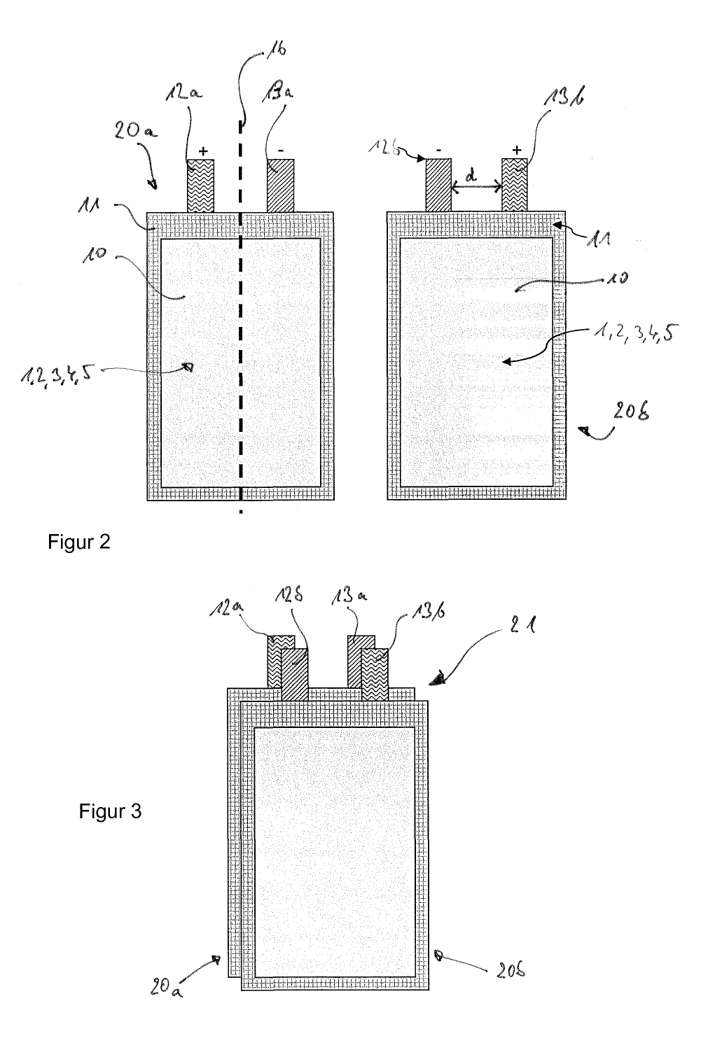

FIG. 3 illustrates two cells arranged in the form of devices according to the present invention,

FIG. 4 is a schematic illustration of a quadrupole arrangement and

FIG. 5 is a schematic illustration of a bifilar winding.

The interior of an electrochemical cell 20a, b as illustrated in FIG. 1 may be provided for a primary or secondary cell. It comprises an anode 1 and a cathode 2. Between them there is positioned a separator 3 on the side of the anode 1. Opposite to the separator 3 there is an anode current collector or accumulator 4, whereas a cathode current collector 5 is provided at the side of the cathode 2 that faces away from the separator 3. Anode 1, cathode 2, separator 3 and anode and cathode current collectors 4, 5 are foil elements of reduced size or thickness, which are shown in FIG. 1 for the purpose of a clear illustration in a magnified manner with not necessarily correct proportions. The cell is soaked with a liquid electrolyte that is present at least in the area of the separator 3, frequently also within the electrodes 1, 2. Moreover, in FIG. 1 the charge currents in the device 21 are illustrated under operating conditions (during discharge), namely on the basis of arrows 6, the electron current in anode 1 and cathode 2 and based on arrow 7 the oppositely directed ion currents are illustrated. An arrow 8 denotes the electron current in the anode current collector 4 and an arrow 9 indicates the electron current in the cathode current collector 5.

Due to the reduced thickness of the anode 1 and the cathode 2, illustrated in FIG. 1 in a strongly magnified manner, and due to the significant extension transverse to the drawing plane the electron currents (arrows 6) and the ion currents (arrows 7) will not generate a magnetic field or will create a negligibly small magnetic field. The electron currents 8, 9 in anode 1 and cathode 2, respectively, are directed oppositely to each other. The magnetic fields generated in this case, which are oriented oppositely to each other due to the oppositely directed electron currents, compensate each other due to the spatially close arrangement of the current collectors 4, 5 that are only separated by the thin foil-like electrodes 1, 2 as well as the separator 3.

FIGS. 2 and 3 illustrate two cells 20a, b in which, for instance, arrangements according to FIG. 1 are incorporated into a respective housing or package 10 that is made of a foil. These foils completely enclose the cells 20a, b, respectively, and each of the housings is hermetically closed by a circumferential sealed seam 11. In order to discharge current for each cell 20a, b a tag 12a, 12b conductively connected with the anode 1 and a tag 13a, 13b conductively connected with the cathode 2 are provided and extend through the housing 10. The tags 12, 13 are positioned with a distance d from each other that may be selected differently depending on the manufacturing or connection requirements. If the tags 12, 13 are not sufficiently closely arranged to each other, a mutual compensation of the magnetic fields surrounding the tags is not or only unsatisfactorily achieved. FIG. 3 illustrates how this fact is taken account of according to the present invention: The two cells 20a, b are formed into a device 21 and are arranged to each other such that the tag 12a connected to the anode 1 of the first cell 20a is adjacent to the tag 13b connected to the cathode 2 of the second cell 20b and the tag 13a connected to the cathode 2 of the first cell 20a is adjacent to the tag 12b connected to the anode 1 of the second cell 20b. The tags 12a, 12b, 13a, 13b form a quadrupole arrangement as schematically shown in FIG. 5, in which the magnetic fields that surround the tags 12a, 12b, 13a, 13b compensate each other and substantially eliminate each other.

The further contacting of the tags 12a, 12b, 13a, 13b is advantageously accomplished by means of conductors 14, 15 that are wound in a bifilar manner according to the type as shown in FIG. 4. In the conductors 14, 15 currents flow in oppositely oriented directions such that also in this case an intensive if not a complete compensation of the generated magnetic fields is achieved.

In a first illustrative arrangement two cells 20a, b according to the present invention are connected in parallel. The connection comprises two identical lithium accumulators as cells in a lithium polymer technology each having a capacity of 2,2 Ah. The position of the tags is symmetric with respect to a length axis of the cells such that the exactly aligned positioning on top of each other of the two cells with exchanged position of the tags results in a quadrupole arrangement in the vicinity of the housing feed throughs. The tags are positioned as close to each other as is compatible with manufacturing techniques. As an electrode pair there is used lithium cobalt oxide LiCoO₂ in the cathode and graphite in the anode. The current dischargers including the housing feed throughs consist of aluminium at the anode side and of copper at the cathode side. By providing insulation between the contact tags positioned atop each other the creation of short circuits is avoided in this area.

In both cells thin copper wires are connected to the tags close to the feed through by soldering through the package foil. The copper wires are routed as two individually bifilarly wound threads to a protective circuitry that is required for this type of lithium accumulator due to safety regulations. The protective circuitry monitors the cells with respect to safety relevant operating states, such as overcharge, deep discharge and short circuit, respectively. Such protective circuitries are available as commercial products from various providers for lithium accumulators. Downstream of the protective circuitry the two cells are connected in parallel with each other and are routed to a load by a bifilarly wound wire pair.

The described configuration has a capacity of 4.4 Ah with an average voltage of 3.7 V. It had been exposed to a strong external magnetic field in order to magnetise any potentially hidden permanent-magnetisable materials. After this pre-treatment the cell pair including the circuitry and without load was positioned on the measurement head of a highly sensitive magnetometer having a resolution of significantly less than 1 nT in order to measure different orientations with respect to stray fields. The result was stray fields between 2 and 3 nT. From this result it may be deduced that no permanent-magnetisable materials were present in the device.

Subsequently, this configuration was loaded with a constant current load of 10 via the load and the configuration was re-measured. Slightly increased field strength values were detected which, however, did not exceed 5 nT. This value is below typical values of the terrestrial magnetic field by a factor of 10 000, wherein the terrestrial magnetic field has values between 20 and 50 μT depending on position and orientation on the surface of the earth.

In a second illustrative assembly or arrangement two cells of the present invention are connected in series. Lithium iron phosphate LiFePO₄ as a cathode material and lithium titanate Li₄Ti₅O₁₂ as an anode material are used in the cells. Two identical cells are arranged such that after positioning the cells on top of each other their feed throughs form a quadrupole arrangement. The capacity of each individual cell is in this case 4.4 Ah. The average voltage in this system is 1.8 V so that the serial connection of the two cells yields an average voltage of 3.6 V. Hence, this arrangement substantially covers the same operating range as the previously described arrangement having a parallel connection. The former arrangement may be used alternatively to the latter one and may provide a plurality of advantages. For example, durability, operating safety or self-discharge rate and temperature operating range are advantageous compared to the previously described parallel connection. However, the energy density with respect to volume and weight is less. Also, the discharge curve that represents the cell voltage as a function of the state of charge is significantly different.

The serial connection is obtained by permanently connecting the plus pole of the cell with the minus pole of the other cell, which are positioned above each other, directly at the housing feed through outside of the battery body. An insulation is attached to the two still non-connected contact tags and a thin flexible cable is attached to each of the tags, which cables are then routed to the load in a bifilarly wound manner. A particular advantage of this serial connection results in the fact that under operational conditions the same current occurs within the entire circuit. This is not necessarily the case in a parallel connection. For example, in the case of varying inner resistances of the cells caused by a different degree of aging, different currents would occur in the respective cells of the parallel connection.

In the serial arrangements described the magnetic measurements were performed identically with respect to example 1. Also in this case stray fields less than 5 nT were obtained.

List of reference signs

| | |
|---|---|
| 1. | Anode |
| 2. | Cathode |
| 3. | Separator |
| 4. | Anode current collector |
| 5. | Cathode current collector |
| 6. | Electron current |
| 7. | Ion current |
| 8. | Electron current |
| 9. | Electron current |
| 10. | Housing or package |
| 11. | Sealed seam |
| 12a, b. | Tag |
| 13a, b. | Tag |
| 14. | Conductor |
| 15. | Conductor |
| 16. | Centre axis |
| 20a. | Cell |
| 20b. | Cell |
| 21. | Device |

1. An electrochemical device for storing and discharging electric energy comprising at least two electrochemical cells (20a, b),
each cell (20a, b) comprising at least
a laminar cathode (2),
a laminar anode (1),
a laminar separator (3),
a cathode current collector (5) connected to the cathode (2) and an anode current collector (4) connected to the anode (1),
each of the cathode and anode current collectors (4, 5) being connected with a tag (12a, b; 13a, b),
characterized in that
the cells (20a, b) are arranged to each other such that a tag (13a) of a cell (20a) connected to said cathode current collector (5) is positioned relative to a tag (12b) of a neighbouring cell (20b) connected to said anode current collector (4) such that the magnetic fields generated by moving electric charges in said tags (13a, 12b) superimpose and substantially compensate each other.

2. The electrochemical device of claim 1, characterized in that the tags (12a, b; 13a, b) of respective two cells (20a, b) that are adjacent to each other, form a quadrupole arrangement.

3. The electrochemical device of claim 1 or 2, characterized in that the cells (20a, b) exclusively include materials that are not ferro-magnets or ferri-magnets and whose magnetic susceptibility is at the same time significantly less than 1.

4. The electrochemical device according to any of the preceding claims, characterized in that the number of cells (20a, b) is 2 or a multiple of 2.

5. The electrochemical device according to any of the preceding claims, characterized in that the cells (20a, b) are primary cells.

6. The electrochemical device according to any of claims 1-5, characterized in that the cells (20a, b) are secondary cells.

7. The electrochemical device according to any of the preceding claims, characterized in that the cells (20a, b) are connected to each other in a parallel or serial manner.

8. The electrochemical device of any of the preceding claims, characterized in that a cell (20a, b), preferably both cells (20a, b) comprise a lithium titanate anode (Li₄Ti₅O₁₂).

9. The electrochemical device of claim 8, characterized in that the cathode and anode current collectors (4, 5) consist of aluminium and/or all tags (12a, b; 13a, b) consist of aluminium only.

10. The electrochemical device of any of claims 1-7, characterized in that tags of the anode (12a, b) consist of copper and/or tags of the cathode (13a, b) consist of Is aluminium.

11. The electrochemical device of any of the preceding claims, characterized in that the tags (12a, b; 13a, b) are positioned symmetrically with respect to a centre axis (16) of the respective cell (20a, b).

12. The electrochemical device of any of the preceding claims, characterized in that it comprises bifilarly wound conductors (14, 15) connected to the current collectors (4, 5) or connected to the tags (12a, b; 13a, b).

13. The electrochemical device of any of the preceding claims, characterized in that the tags (12a, b; 13a, b) are configured in the form of thin metal bands.

14. A method of fabricating an electrochemical device according to any of the preceding claims, comprising the steps:
providing at least two primary or secondary cells (20a, b) configured as thin cells,
positioning the cells (20a, b) such that the cells (20a, b) are adjacent to each other with a plane side thereof and such that the tags (12a, b; 13a, b) of one cell (20a) form a quadrupole arrangement with the tags of an adjacent cell (20b).

15. The method of claim 14 characterized in that the cells (20a, b) are connected in parallel or serial preferably by means of bifilarly wound conductors (14, 15).
